(19) United States
(12) Patent Application Publication
(10) Pub. No.: US 2004/0165202 A1
(43) Pub. Date: Aug. 26, 2004

(54) Image forming apparatus and image forming method

(75) Inventor: Kunihiro Nakagawa, Shizuoka-ken (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/784,167

(22) Filed: Feb. 24, 2004

(30) Foreign Application Priority Data
Feb. 25, 2003 (JP) 2003-048067

(51) Int. Cl. H04N 1/387; H04N 1/409; G06T 3/60; G06T 5/00; G06K 15/02

(52) U.S. Cl. 358/1.9; 358/3.26; 358/1.18; 358/1.17; 382/296

(57) ABSTRACT

Image data, for example, image data that was gradation processed and replaced with a raster image is stored in every page of a page memory. The image data stored in this page memory is rotated in the left or right direction by 90° at a specified angle. By this rotation of image data, pixels with positional relation changed from that before the rotation are corrected to come near to the positional relation before the rotation. Then, an image is formed based on image data with the corrected positional relation of pixels.

### CROSS-REFERENCE TO RELATED APPLICATIONS

This application is based upon and claims the benefit of priority from the prior Japanese Patent Application No. 2003-048067, filed on Feb. 25, 2003; the entire contents of which are incorporated herein by reference.

### BACKGROUND OF THE INVENTION

1. Field of the Invention

This invention relates to such image forming apparatus as Multi-function Peripherals (MFP), digital copying machines, page printers and the like and in particular to an image forming apparatus with a function incorporated to form an image by rotating it at a specified angle.

2. Description of the Related Art

An image forming apparatus such as an MFP, digital copying machine, page printer, etc. are connected to a computer directly or through a network and is also used as a network printer to print and output documents, images, etc. on paper after editing on that computer.

In this case, a printer driver is mounted to a computer. This printer driver is for converting document data such as original documents, images, etc. that are subject to print into Page Description Language (PDL). On the other hand, a Raster Image Processor (RIP) is mounted in an image forming apparatus. This RIP is to translate PDL and convert manuscript data into raster image composed of assembled dots. RIP reproduces halftone image data through the halftone process, etc. The halftone process is a method to express dark and light coloring with an occupied area ratio of pattern such as points or lines. Image data converted (rasterized) into a raster image is printed on a specified paper and output by the printer engine.

Some of this type of image forming apparatus have a function to form an image by rotating it at a specified angle when required based on information relative to document size, paper size, paper supply direction, etc. For example, when document data sent from a Personal Computer (PC) is A4 size, longitudinal paper data while A4 size paper packed in a paper supply cassette for conveying in the horizontally long state only is available in an image forming apparatus, this image forming apparatus forms an image of document data by automatically rotating the image by 90°. Definitely, image data expressed in the raster image on a page memory is developed by rotating it 90° in the left or right direction as disclosed in the Japanese Patent Publication No.6-86050.

However, in an image forming apparatus provided with a conventional image rotation function, when image data developed in a raster image on a page memory is rotated, the same pixel array pattern as that before and after the rotation may not be obtained in some cases.

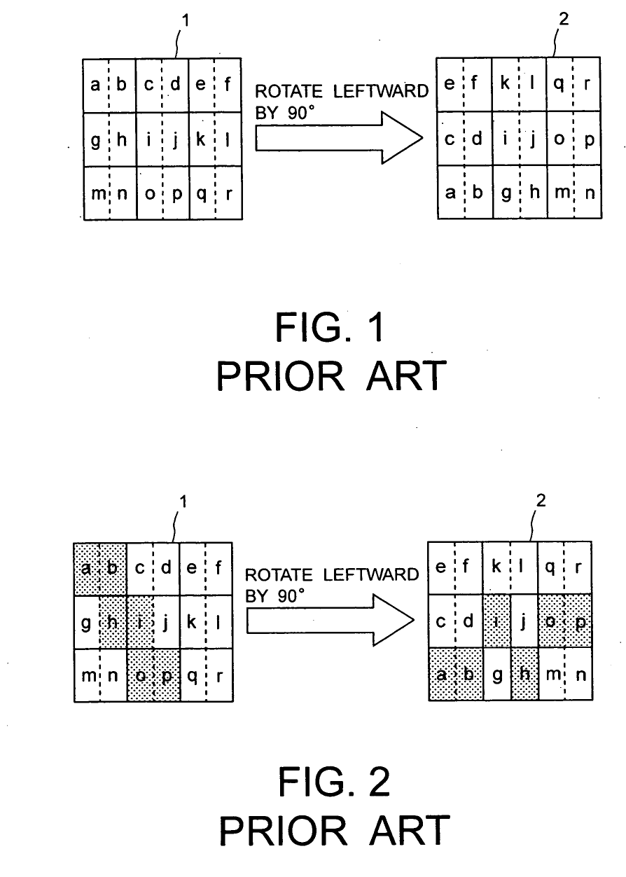

FIG. 1 is a pattern diagram showing the positional relationship of pixels a through r when an image expressed in a matrix pixel array pattern with 6 pixels arranged in the lateral direction over 3 lines was rotated leftward by 90°. A pixel array pattern 1 shows the state before the rotation and a pixel array pattern 2 shows the state after the rotation. Here, two pixels laterally arranged are treated as one block, which is then rotated leftward by 90°.

As shown in FIG. 2, in the case of an image forming apparatus having such an image rotation system, when an image data comprising 6 pixels a, b, h, i, o and p which become black pixels and other 12 pixels c, d, e, f, g, j, k, l, m, n, q and r which become white pixels as a result of the halftone process was rotated in the left direction by 90°, the positional relationship of the black pixels a, b, h, i, o and p in pixel array pattern 2 after the rotation differs largely from that of the black pixels a, b, h, i, o and p in pixel array pattern 1 before the rotation. Definitely, the positional relationship of third and fourth pixels from the left of the second line differs from that of the third and fourth pixels from the left of the third line. As a result, there was such a problem that the picture quality differs largely before and after the rotation.

### SUMMARY OF THE INVENTION

This invention is made based on the such circumstances as described above and it is an object of this invention to provide an image forming apparatus and an image forming method that are able to reduce deterioration of image quality generated when an image is rotated.

According to this invention, there are provided an image forming apparatus comprising a page memory to store image data for every page; image rotating means for rotating the image data stored in the page memory at a specified angle; image correction means for correcting pixels of which positional relationship was changed from that before rotation as a result of the rotation of the image data by the image rotating means to come near to the positional relationship before the rotation; and image forming means for forming images based on the image data of which the positional relationship of pixels was corrected by the image correction means.

Further, according to this invention, there are provided an image forming method comprising storing image data for every page; rotating the stored image data at a specified angle; correcting pixels in the rotated image data of which positional relationship before and after the rotation has changed to come near the positional relationship before the rotation; and forming an image based on the corrected image data.

### DETAILED DESCRIPTION OF THE DRAWINGS

FIG. 1 is a schematic diagram showing the relation of positions of pixels in a leftward 90° image rotating system;

FIG. 2 is a pattern diagram showing an image arranging pattern example that is used in the conventional problem explanation;

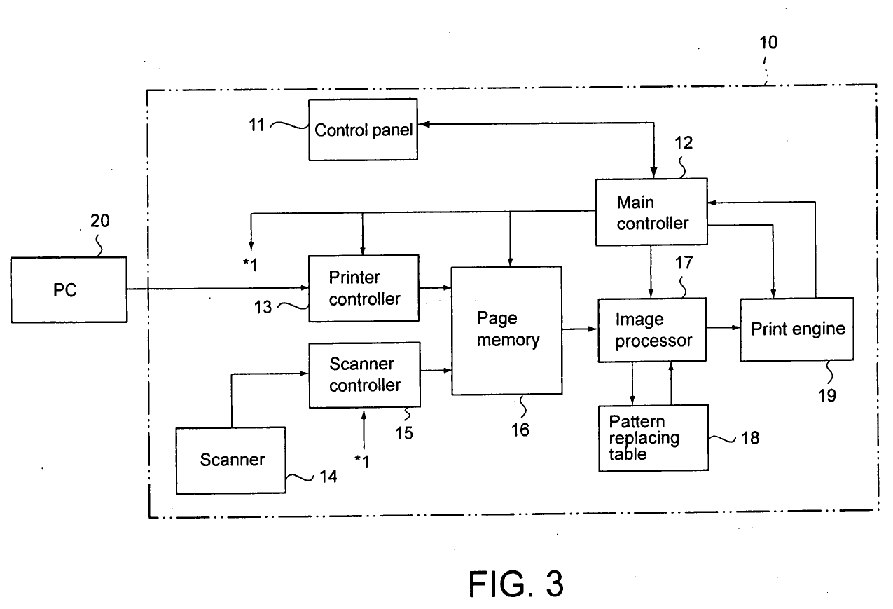

FIG. 3 is a block diagram showing the construction of essential portions of MFP in the first and second embodiments of this invention;

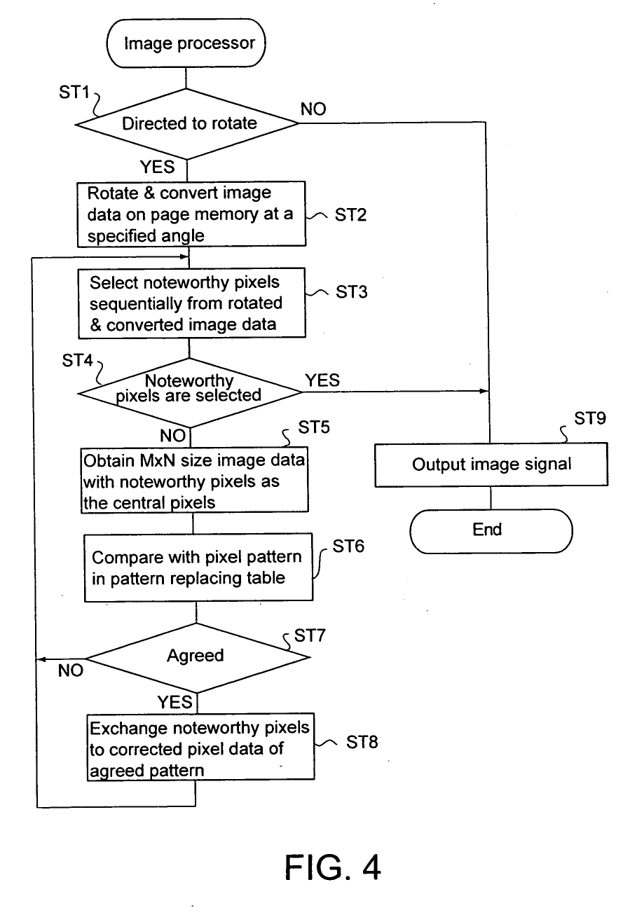

FIG. 4 is a flowchart showing principal processing steps of an image processor in the first embodiment;

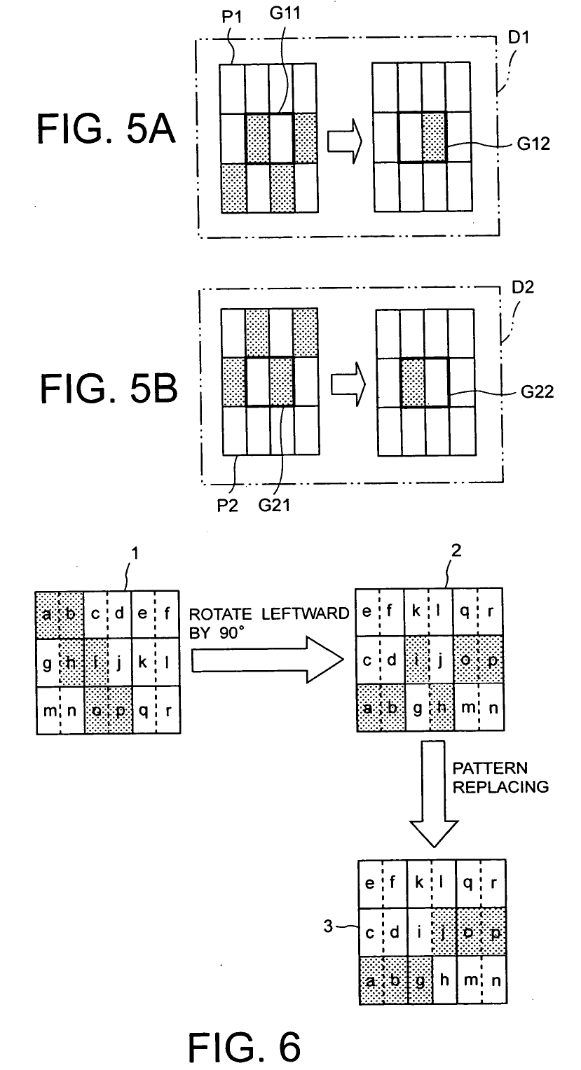

FIGS. 5A-B are pattern diagrams showing an example of a pattern of replaced data in the first embodiment;

FIG. 6 is a pattern diagram showing an example of a pixel array pattern that is used in the explanation of action in the first embodiment;

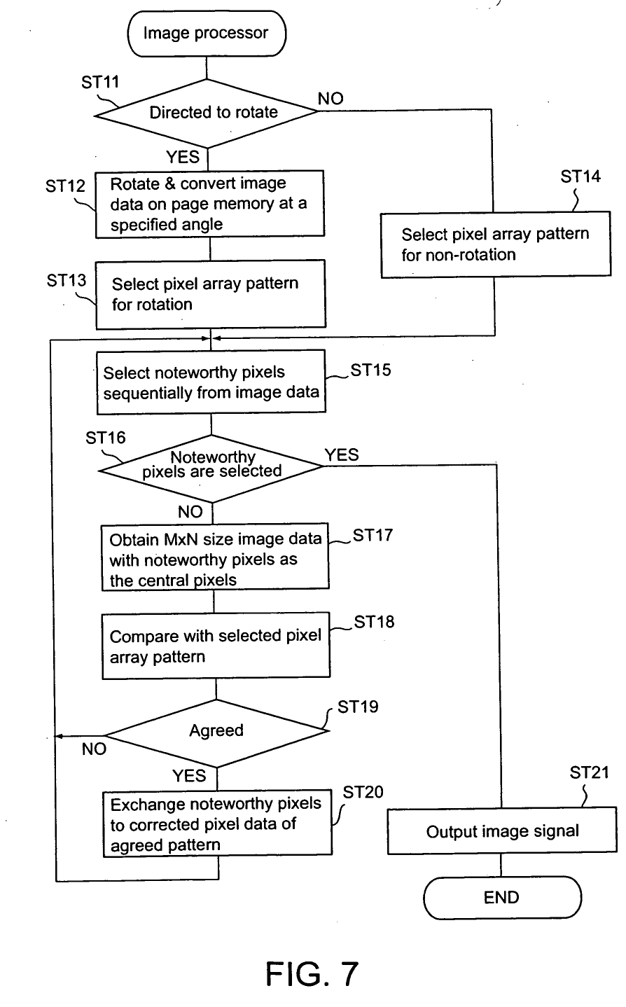

FIG. 7 is a flowchart showing the principal processing steps of the image processor in the second embodiment;

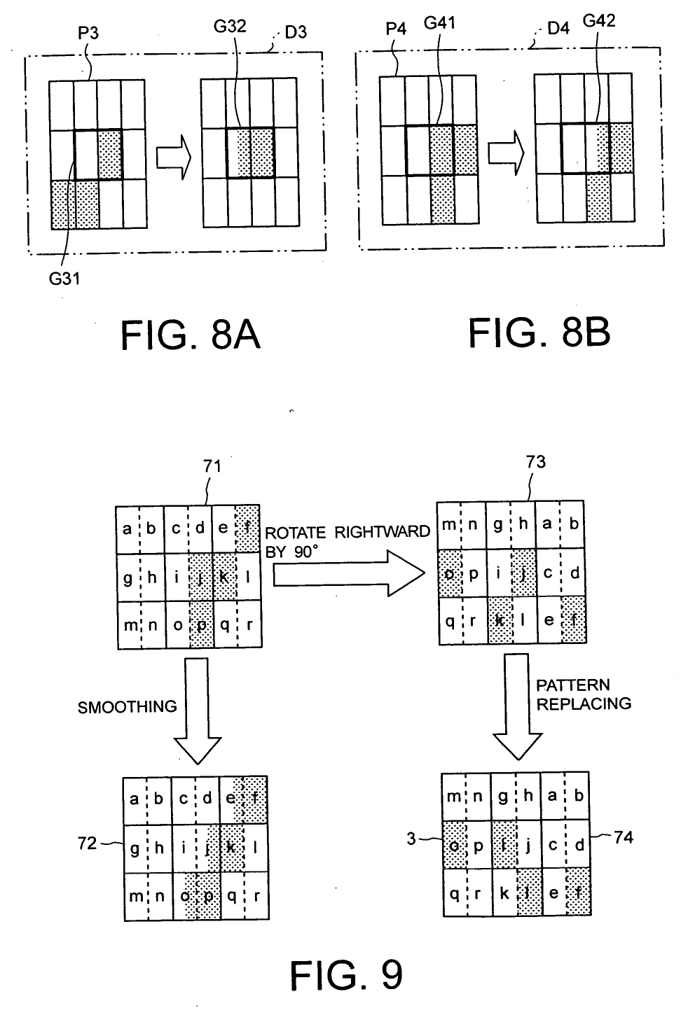

FIGS. 8A-B are pattern diagrams showing an example of a non-rotating pattern of replaced data in the second embodiment;

FIG. 9 is a pattern diagram showing one example of the rightward 90° rotation in the second embodiment;

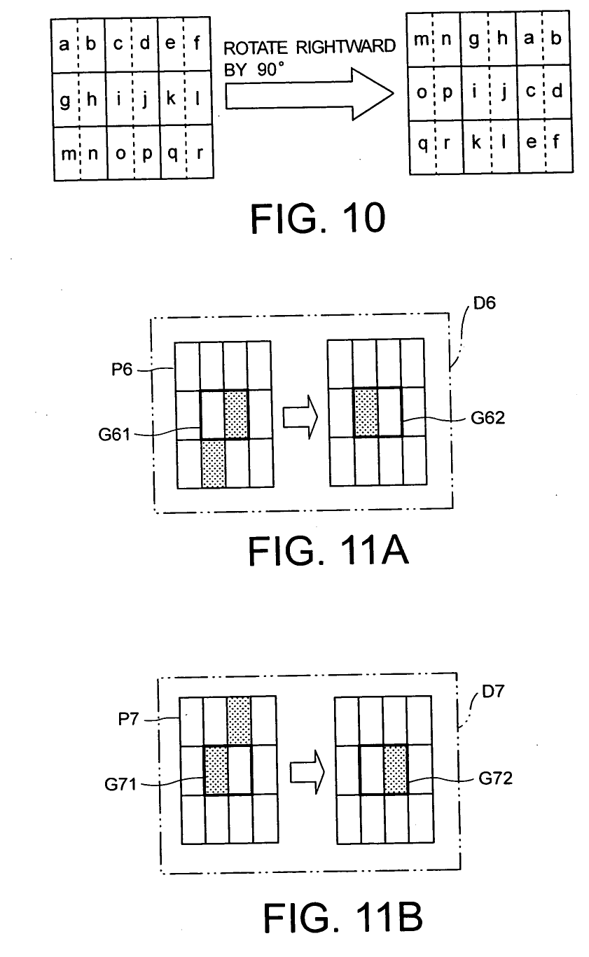

FIG. 10 is a schematic diagram showing the relation of positions of pixels in a rightward 90° image rotating system; and

FIGS. 11A-B are pattern diagrams showing pixel arranging pattern examples that are used in the explanation of the actions in the second embodiment.

### DETAILED DESCRIPTION OF THE INVENTION

Embodiments of this invention will be explained below using attached drawings. A first embodiment of this invention will be first explained referring to FIG. 3 through FIG. 6.

FIG. 3 is a block diagram showing the structure of essential parts of an MFP 10 that is an example of an image forming apparatus of this invention. MFP 10 comprises a control panel 11, a main controller 12, a printer controller 13, a scanner 14, a scanner controller 15, a page memory 16, an image processor 17, a pattern replacing table 18, a print engine 19, etc.

Control panel 11 comprises a key portion and a display portion. On the key portion, ten keys for inputting number of printing copies, paper selecting keys for selecting paper sizes such as A4, B5, B4, A3, etc. are arranged. On the display portion, display areas for number of printing sheets, paper size, etc. are formed.

Main controller 12 processes signals input by the operating key through main control panel 11 and controls the data display of this control panel 11. Main controller 12 also controls printer controller 13, scanner controller 15, page memory 16, image processor 17 and print engine 19.

When document data that are replaced into PDL are received from a PC connected through a network, printer controller 13 translates PDL into raster image by RIP and stores this rasterized binary image data in page memory 16. At this time, when document data are for multi-valued images, printer controller 13 executes a gradation process such as a halftone process, etc. and reproduces halftone.

Scanner 14 reads image data of a document placed on a document table (not shown).

Scanner controller 15 binarizes the image data read by scanner 14 and stores the resulting binary image data in page memory 16.

Page memory 16 stores binary image data sent from printer controller 13 or scanner controller 15 for every page (Storage Step). Here, page memory 16 constructs a storage means. Further, one pixel of page memory 16 is binarized data.

Image processor 17 sequentially processes image data stored in page memory 16 by the control of main controller 12, and generates 8-bit image signals, performing image processing such as smoothing, etc. Further, after this image processing, print engine 19 outputs an image by pulse width modulation.

Out of image data pixels that are rotated and converted on page memory 16 according to the rotating direction from main controller 12, pixels requiring correction because the positional relationship differs before and after the rotation are decided as pixels subject to replacement. For an M×N (M and N are positive numbers more than 2) size matrix pixel array pattern having pixels subject to replacement at the center thereof, pixel data with the positional relationship corrected is held. What is holding this corrected pixel data is pattern replacing table 18. Further, one pixel of the corrected pixel data is 8-bit.

At the state of manufacturing MFP1, image data of which the pixel array pattern differs largely before and after the rotation, especially, halftone processed image data is examined in advance and pixels of which rotational position was changed are regarded as pixels subject to replacement. Then, a corrected pixel array pattern of which positional relationship is corrected so as to come near the pixel array pattern before the rotation is prepared for the M×N size matrix pixel array pattern having the pixel subject to replacement at the center thereof. This corrected pixel array pattern is registered in pattern replacing table 18 (Holding Step). Pattern replacing table 18 is formed on an EEPROM chip that is detachable to MFP1 and data can be replaced when necessary.

Print engine 19 functions as an image forming means to form images based on image signals from image processor 17. Print engine 19 prints a formed image on a paper and outputs it by operating a printer (not shown). Here, it is assumed that document data sent from PC 20 is data for A4 size longitudinal paper. However, when A4 size paper contained in a paper supply cassette loaded in MFP1 is only available to be conveyed in the horizontally long state, it is necessary to rotate and convert the longitudinal image data into horizontally long image data. Therefore, main controller 12 gives a direction to image processor 17 to rotate.the image. Upon receipt of this rotating direction, image processor 17 executes the processes shown in the flowchart shown in FIG. 4.

That is, when the rotating direction is received from main controller 12 (YES in ST1), image processor 17 rotates and changes binary image data stored in page memory 16 at a specified angle according to a specified image rotation system (ST2: Rotating Step, Image Rotating Means). Here, an image rotating system to treat laterally arranged two pixels as one block and rotate each block to the left direction by 90° is applied (Refer to FIG. 1).

Then, image processor 17 sequentially selects noteworthy pixels from the rotated and converted image data (ST3). For example, a pixel at the left end and its right hand pixel, the second pixel from the left end of the first line, are first selected as noteworthy pixels. Then, a pixel at such right hand pixel's right hand, the third pixel from the left endand its right hand pixel, the fourth pixel from the left end, are selected as noteworthy pixels. Thereafter, shifting to the right side, laterally arranged two pixels are selected as noteworthy pixels. After selecting the right end pixel of the first line, two pixels from the left end of the second line are selected as noteworthy pixels. Thus, noteworthy pixels are selected in this order. Then, whenever noteworthy pixels are selected, M×N size matrix image data are acquired from image data rotated with this noteworthy pixel as the central pixel (ST5).

Next, the same size rotated pixel array pattern that was M×N size image data with the noteworthy pixel as the central pixel set in pattern replacing table 18 is searched and the presence of patterns of which white and black pixel array agrees with the M×N size image data (ST6: Search Step, Image Data Searching Means) is judged.

Here, when the rotated pixel array pattern, in which M×N size image data having a noteworthy pixel at center thereof which is in accord with the white and black pixel array, is set in pattern replacing table 18 (YES in ST7), image processor 17 replaces the noteworthy pixel into noteworthy pixel data of the corrected image array pattern that is pre-set for the same pattern. By this replacement, the positional relationship of pixel array pattern is corrected to come near the state before the rotation (ST8: Image Correction Means). When the rotated pixel array pattern which is agreed to with the white and black pixel array was not set in pattern replacing table 18 (NO in ST7), the noteworthy pixel replacement is not executed.

Whenever noteworthy pixels are selected in ST3, image processor 17 executes the steps ST5 through ST8 described above repeatedly. Then, when the above-mentioned processes are executed by selecting the last pixel of the rotated image data (YES in ST4), image processor 17 generates an 8-bit image signal based on this corrected image data. This generated image signal is output to print engine 19 for the image formation (ST9). At this time, it is also possible to generate the image signal by executing the pattern correction performed as a smoothing process for the image data.

In this embodiment in the structure as described above, for example, when a 3 lines×6 pixels halftone processed image array pattern shown as reference numeral 1 in FIG. 1 was rotated by 90° leftward according to the image rotation system shown in FIG. 1, the pixel array pattern after the rotation becomes the pattern shown by reference numeral 2 in FIG. 6 and it can be seen that the positional relationship of the pixels before the rotation will change. Further, reference letters a to r in FIG. 6 correspond to reference letters a to r of pixel array patterns 1 and 2 in FIG. 1.

In this case, pattern replacing data D1 shown in FIG. 5A and pattern replacing data D2 shown in FIG. 5B are registered in pattern replacing table 18. Both of pattern replacing data D1 and D2 are laterally arranged two pixels subject to correction G11 and G21. With these pixels subject to correction G11 and G21 as the central pixels, M (vertical)×N (horizontal)=3×4 matrix image data are made the rotated pixel array patterns P1 and P2. These corrected data G12 and G22 of pixels subject to correction G11 and G21 are set for the rotated pixel array patterns P1 and P2.

Thus, when pixels i and j of pixel array pattern 2 shown in FIG. 6 are regarded as noteworthy pixels, pixels f, k, l, q, d, i, j, o, b, g, h and m are in accord with the rotated pixel array pattern P1 of pattern replacing data D1 and therefore, noteworthy pixels i and j are replaced to corrected data G12.

Further, when pixels g and h of rotated pixel array pattern 2 are regarded as noteworthy pixels, pixels d, i, j, o, b, g, h and m are in accord with rotated pixel array pattern 2 of pattern replacing data D2 (“0” of the third line=white) and noteworthy pixels g and h are replaced to corrected data G22.

Thus, image data of pixel array pattern 2 becomes data of pixel array pattern 3 and comes near to the pixel array of pixel array pattern 1. In print engine 19, the image formation is executed based on image data of this pixel array pattern 3. Accordingly, deterioration of image quality caused when an image is rotated is extremely smaller than that of the image formation based on the image data of pixel array pattern 2.

As described above, according to this embodiment, as image data stored for every page of page memory 16 was rotated on this page memory 16, even when the positional relationship of the pixel array before the rotation changes, pixels of which positional relationship is changed are automatically corrected so as to come near to the positional relationship before the rotation. As an image is formed based on image data of which positional relationship is corrected, deterioration of image quality caused when an image is rotated can be suppressed and the image quality is maintained at a constant level.

Next, a second embodiment will be explained using FIG. 7 through FIG. 11.

Further, this second embodiment is also applicable to MFP 10 as one example of an image forming apparatus and the construction of essential component portions is the same as the first embodiment and the detailed explanation thereof will be omitted here. In this second embodiment, pixels subject to replacement are those pixels requiring correction as the positional relationship of image data changes from that before rotation when image data are rotated. For a matrix pixel array pattern having the pixels subject to replacement at rotation center thereof (rotating pixel array pattern), corrected pixel data of which rotational positions come near to the pixel array pattern before rotation are held in pattern replacing table (rotating pixel correction pattern holding means) 18 (the first holding step). At the same time, pixels on which correction is performed to enhance the image quality when not rotating are those non-rotating time pixels subject to replacement. For a matrix pixel array pattern with these pixels subject to replacement when not rotated (non-rotating pixel array pattern), correction pixel data to enhance the image quality is held in pattern replacing table (correction pattern when not rotated holding means) 18 (the second holding step).

Image processor 17 executes the processing shown in the flowchart in FIG. 7. That is, when the rotating direction of images stored in page memory 16 is received from main controller 12 (YES in ST11), image processor 17 converts binary image data stored in page memory 16 by rotating at a specified angle according to the specified image rotation system (ST12: Rotation Step, Image Rotating Means). After this rotary conversion, a rotary pixel array pattern is selected from pattern replacing table 18 (ST13). Further, binary image data stored in page memory 16 may be rotated and converted after selecting the rotating pixel array pattern from pattern replacing table 18. On the contrary, when no direction for image rotation is received (NO in ST11), a non-rotating pixel array pattern is selected from pattern replacing table 18 (ST14). Thereafter, image processor 17 selects noteworthy pixels sequentially from rotary converted image data or not rotary converted image data (ST15). Further, the noteworthy pixel selecting method is the same as that in the processing in ST3. When a noteworthy pixel is selected, image processor 17 acquires M×N size matrix image data from image data on page memory 16 with this noteworthy pixel located at center thereof (ST17). Then, presence of a pattern with the arrays of white and black pixels in accord with each other is judged by comparing M×N size image data with the pixel array pattern selected from pattern replacing table 18 (ST18).

Here, when M×N size image data having a noteworthy pixel located at the center thereof agreeing with a white and black pixel array and a pixel array pattern were set in pattern replacing table 18 (YES in ST19), image processor 17 replaces the noteworthy pixel to the pixel located at the center of the corrected pixel array pattern that is preset for the pixel array pattern. As a result of this replacement, the positional relationship of pixel array pattern is corrected (ST20: Image Correction Means). When M×N size image data having a noteworthy pixel located at the center thereof agreeing with a white and black pixel array pattern was not set (NO in ST19), the noteworthy pixels are not replaced.

Whenever a noteworthy pixel is selected in ST15, image processor 17 repetitively executes the processes in ST17 through ST20 described above. And, when the above-mentioned processes are executed by selecting the last pixel of image data as a noteworthy pixel (YES in ST16), image processor 17 generates an image signal based on this corrected image data, outputs this image signal to print engine 19 for executing the image formation (ST21).

In the second embodiment constructed as described above, for example, when a halftone processed pixel array pattern of 3 lines×6 pixels shown by reference numeral 1 in FIG. 6 was rotated leftward by 90° according to the image rotation system shown in FIG. 1, rotary pattern replacement data D1 and D2 shown in FIG. 5 are registered in advance in pattern replacing table 18. By this registration, deterioration of image quality caused when an image was rotated can be minimized.

Further, when non-rotating pattern replacing data D3 and D4 shown in FIG. 8A and 8B are pre-registered in pattern replacing table 18, image quality can be enhanced when an image was not rotated. In addition, in pattern replacing data D3 and D4, laterally arranged two pixels are made pixels subject to correction G31 and G41, and M (vertical)×N (lateral)=3×4 matrix image data with these pixels G31 and G41 subject to correction as the central pixels become non-rotating pixel array patterns P3 and P4. And corrected data G32 and G42 of correction subject pixels G31 and G41 are set for non-rotating pixel array patterns P3 and P4, respectively.

For example, when image data of halftone processed pixel array pattern of 3lines×6 pixels shown by reference numeral 71 in FIG. 9 are not rotated and pixels e and f are regarded as noteworthy pixels, pixels d, e, f, j, k and l are in accord with non-rotating pixel array pattern P3 of pattern replacing data D3 and therefore, noteworthy pixels e and f are replaced to corrected data G32. Further, when pixels i and j are regarded as noteworthy pixels, pixels b, c, d, e, h, i, j, k, n, o, p and q are in accord with non-rotating pixel array pattern P4 of pattern replacing data D4 and therefore, the noteworthy pixels i and j are replaced to corrected data G42. That is, only one cell adds a blank cell on d, e and f, using cells e and f as noteworthy pixels, and only one cell adds a blank cell to the right of f and i, and only one cell adds a blank cell to the diagonal right of f. Therefore, e and f cells of 72 of the right figure of FIG. 8A and FIG. 9 overlap each other.

Thus, image data of a pixel array pattern 71 becomes data of a pixel array pattern 72 and the same result as that when the smoothing process is executed for achieving a high image quality is obtained, and it becomes possible to achieve an image of high quality.

Further, in the embodiments described above, a case wherein laterally arranged two pixels are treated as one block and every block is rotated leftward by 90° is shown as an image rotation system. However, the image rotation system is not restricted to this system. For example, a system can be such that laterally arranged two pixels are treated as one block and every block is rotated rightward by 90° as shown in FIG. 10. Although a noteworthy pixel being located at the center of the image data of M×N size is chosen, it may be located not only at a center thereof.

In the second embodiment described above, when the image rotation system is of rightward rotation type, the image data of pixel array pattern 71 becomes a pixel array pattern 73 as a result of the rotary conversion and the positional relationship between white pixels and black pixels differs much more than with pixel array pattern 71 before rotation. In this case, therefore, pattern replaced data D6 shown in FIG. 11A and pattern replaced data D7 shown in FIG. 11B should be registered in pattern replacing table 18. In both pattern replaced data D6 and D7, laterally arranged two pixels are pixels which are subject to correction G61 and G71, and M (vertical)×N (lateral)=3×4 matrix image data having the correction subject data G61 and G71 at center thereof become rotated pixel array patterns P6 and P7. Then, corrected data G62 and G72 of correction subject pixels G61 and G71 are set for rotated pixel array patterns P6 and P7.

Thus, when pixels i and j of pixel array pattern 73 are made noteworthy pixels, pixels n, g, h, a, p, i, j, c, r, k, l and e are in accord with rotated pixel array pattern P6 of pattern replacement data D6 and therefore, noteworthy pixels i and j are replaced to corrected data G62. Further, when pixels k and l are made noteworthy pixels, pixels p, 1, j, c, r, k, l and e are in accord with rotated pixel array pattern P7 of pattern replacement data D7 and therefore, noteworthy pixels k and l are replaced to corrected data G72. Thus, image data of pixel array pattern 73 becomes data of pixel array pattern 74 and comes near to the pixel array of pixel array pattern 71.

Further, the image forming apparatus of this invention is not restricted to MFP1 but is applicable to multi functional peripherals such as a digital copier, page printer, etc. with an image rotating function incorporated. In addition, the image forming method is applicable not only to document data received from PC 20 but a similar image forming method is also applicable to image data of documents read through scanner 14.

According to this invention described above in detail, an image forming apparatus is capable of minimizing deterioration of image quality caused when images are rotated and maintaining a constant image quality. Further, a high quality image can be obtained when images are not rotated.

What is claimed is:

1. An image forming apparatus comprising:
a page memory to store image data for every page;
image rotating means for rotating the image data stored in the page memory at a specified angle;
image correction means for correcting pixels of which positional relationship was changed from that before rotation as a result of the rotation of the image data by the image rotating means to come near to the positional relationship before the rotation; and
image forming means for forming images based on the image data of which the positional relationship of pixels was corrected by the image correction means.

2. An image forming apparatus comprising:
a page memory to store image data for every page;
image rotating means for rotating the image data stored in the page memory at a specified angle;
corrected pattern holding means for regarding pixels requiring correction as replacing subject pixels when the image rotating means rotates the image data and holding the image data after correcting a matrix pixel array pattern including the replacing subject pixels as noteworthy pixels;
image data searching means for searching image data in accord with the matrix pixel array pattern held by the corrected pattern holding means out of rotary processed image data by the image rotating means;
image correcting means for correcting the replacing subject pixels with the pixel array pattern when the image data searching means detect the image data in accord with the pixel array pattern; and
image forming means for forming an image based on the image data corrected by the image correcting means.

3. The image forming apparatus according to claim 2, wherein the noteworthy pixels are located at the central portion of the matrix pixel array pattern.

4. The image forming apparatus according to claim 2, wherein the corrected pattern holding means makes pixels of which positional relationship differs from that before the rotating when halftone processed image data is rotated as pixels subject to replacement and holds corrected pixel data of which positional relationship was corrected for the matrix pixel array pattern including the replacing subject pixels as noteworthy pixels.

5. An image forming apparatus comprising:
a page memory to store image data for every page;
image rotating means for rotating the image data stored in the page memory at a specified angle;
first pattern holding means for regarding pixels required for correction as rotation-subject pixels when the image rotation means rotates the image data and for holding first image pixel data that are corrected with respect to a matrix pixel array pattern including the rotation subject pixels as noteworthy pixels;
second pattern holding means for regarding pixels required for correction as non-rotation subject pixels when the image rotation means does not rotate the image data and for. holding second image pixel data that are corrected with respect to a matrix pixel array pattern including the non-rotation subject pixels as noteworthy pixels;
image correction means for replacing the first image pixel data with noteworthy pixels of the image data that are in consistent with the first image pixel data when the image rotation means rotates the image data stored in the page memory and for replacing the second image pixel data with noteworthy pixels of the image data that are in consistent with the second image pixel data when the image rotation means does not rotate the image data stored in the page memory; and
image forming means for forming an image based on the image data corrected by the image correction means.

6. An image forming method comprising:
storing image data for every page;
rotating the stored image data at a specified angle;
correcting pixels in the rotated image data of which positional relationship before and after the rotation has changed to come near the positional relationship before the rotation; and
forming an image based on the corrected image data.

7. An image forming method comprising:
regarding pixels requiring correction as replacing subject pixels when image data is rotated at a specified angle and holding the image data after correcting a matrix pixel array pattern including the replacing subject pixels as noteworthy pixels;
storing image data for every page;
rotating the stored image data at a specified angle;
searching image data in accord with the matrix pixel array pattern held out of rotary processed image data;
correcting by replacing subject pixels with the pixel array pattern when the image data in accord with the pixel array pattern is detected; and
forming an image based on the corrected image data.

8. An image forming apparatus according to claim 6, wherein the correction step decides pixels of which positional relationship differ from that before the rotation when halftone processed image data was rotated as pixels subject to replacement and holds the pixel data of which positional relationship was correct for the matrix pixel array pattern including the subject pixels as noteworthy pixels.

9. An image forming method comprising:
a first holding step to regard pixels required for correction as rotation subject pixels when the image is rotated at a specified angle and for hold first image pixel data that are corrected with respect to a matrix pixel array pattern including the rotation subject pixels as noteworthy pixels;
a second holding step to regard pixels required for correction as non-rotation subject pixels when the image data is not rotated and hold second image pixel data that are corrected with respect to a matrix pixel array pattern including the non-rotation subject pixels as noteworthy pixels;
a storing step to store image data for every page;
a rotation step to rotate the stored image data at a specified angle;
a correction step to replace pixels at the center of image data conforming to the matrix pixel array pattern held in the first holding step when image data stored in the storing step is rotated and replaced in the rotation step and when not replaced by rotating, replace pixels at the center of image data conforming to the matrix pixel array pattern held in the second holding step to the corrected matrix pixel data of the pixel array pattern, and
a correction step to replace the first image pixel data with noteworthy pixels of the image data that are in consistent with the first image pixel data when the image rotation step rotates the image data stored in the storing step and to replace the second image pixel data with noteworthy pixels of the image data that are in consistent with the second image pixel data when the image is not rotated; and
a step to form an image based on the image data corrected in the correction step.

10. An image forming apparatus comprising:
a page memory configured to store image data for every page;
an image processor connected to the page memory, wherein the page memory rotates the image data stored in the page memory at a specified angle and corrects pixels of which positional relationship was changed from that before rotation as a result of the rotation of the image data to come near to the positional relationship before the rotation; and
a print engine configured to form images based on the image data of which positional relationship of pixels was corrected by the image processor.

11. An image forming apparatus comprising:
a page memory configured to store image data for every page;
an image processor connected to the page memory, wherein the image processor rotates the image data stored in the page memory at a specified angle;
a pattern replacing table configured to make pixels requiring correction when rotating the image data by the image processor and hold corrected pixel data for a matrix pixel array pattern having a pixel located at a center thereof with the pixel subject to replacement;
wherein the image processor searches the image data in accord with the matrix pixel image array pattern held by the pattern replacing table out of rotary processed image data and replaces a pixel subject to replacement that is the central pixel of the image data when image data in accord with the matrix pixel image array pattern is searched; and
a print engine configured to form images based on the image data of which positional relationship of pixels was corrected by the image processor.
